(19) United States
(12) Patent Application Publication
(10) Pub. No.: US 2026/0027490 A1
(43) Pub. Date: Jan. 29, 2026

(54) DEVICES AND METHODS FOR USING PHOTONS FOR DRYING, DEHUMIDIFYING, FLUID PROCESSING, DEHYDRATING, AND EVAPORATING APPLICATIONS

(71) Applicants: Robert Nicholas Haring, San Diego, CA (US); Matthew W. Losey, Livermore, CA (US)

(72) Inventors: Robert Nicholas Haring, San Diego, CA (US); Matthew W. Losey, Livermore, CA (US)

(21) Appl. No.: 19/277,015

(22) Filed: Jul. 22, 2025

Related U.S. Application Data
(60) Provisional application No. 63/676,352, filed on Jul. 27, 2024.

(51) Int. Cl. B01D 1/00

(52) U.S. Cl. CPC B01D 1/0029; B01D 2259/802

(57) ABSTRACT

Devices and methods are disclosed for enhancing drying, dehumidifying, cooling, dehydrating, and evaporating processes by harnessing direct, non-thermal photon-induced removal of liquid molecules from a surface. Each apparatus integrates a configurable photon-emitting module (LED, laser, or array) that delivers predominantly TM-polarized light in the visible band (e.g., 495 nm-570 nm) at an incidence configured to approximate the Brewster angle, such as within ±5° of the Brewster angle. Placement of these light sources, together with light-permeable or patterned surfaces, maximizes the normal electric-field component at the interface and enlarges the illuminated area, thereby enhancing cluster ejection and vapor formation while minimizing bulk heating. Representative embodiments include a regenerating desiccator, clothes dryer, solvent extractor, indirect and direct evaporative coolers, food dehydrator, and a valveless microfluidic pump. Integrated control units modulate wavelength, pulse width, incidence geometry, airflow, and ancillary actuators in real time to match load and environmental conditions.

### RELATED APPLICATIONS

This application claims the benefit of priority of U.S. Provisional Patent Application Ser. No. 63/676,352, entitled “DEVICES AND METHODS FOR USING PHOTONS FOR DRYING, DEHUMIDIFYING, CLEANING, DEHYDRATING, AND EVAPORATING APPLICATIONS,” and filed on Jul. 27, 2024. The contents of the foregoing application are hereby expressly incorporated by reference for all purposes.

### TECHNICAL FIELD

The present application relates to drying and fluid processing devices, more particularly, to devices and methods for performing drying, dehumidifying, dehydrating, fluid processing and/or evaporating liquids such as hair and clothes drying, heating and cooling building spaces, water damage remediation, food preservation, and to systems and methods for using such devices.

### BACKGROUND

The state-of-the-art devices for drying, evaporating, dehydrating, fluid processing or dehumidifying rely on heat and/or air convection. As some examples, clothes dryers typically use a tumbler comprising a rotating drum with baffles and circulating heated air into the drum to dry clothing, water damage remediation dryers use large air blowers and sometimes heaters to dry carpet, flooring and structures suffering water damage, etc.

Traditional drying methods are inherently limited by their reliance on thermal energy transfer, requiring significant energy input to overcome water's latent heat of vaporization. This thermal limitation has driven decades of research into improving heat transfer efficiency, optimizing airflow patterns, and recovering waste heat. However, all these approaches remain fundamentally constrained by the thermodynamic limits of thermal evaporation.

It has been recently discovered that, without heat, and under certain conditions, light can cleave parcels of water molecules from the surface of the water into the adjacent air interface. Those clusters absorb the incident light, and the energy assists the breakdown of the molecule clusters into vapor phase water molecules. This direct, non-thermal photon-induced (NTPI) removal of liquid molecules from a surface has been called the photomolecular effect. The effect may not be limited only to liquids or specifically water, it may also apply to other fluids or interfaces including solids and gases, subject to absorption and field conditions.

Photons striking the surface of an object or fluid can create a directional gradient in the electric field that is present at the surface interface. This gradient creates a net force cleaving molecules from the object and transferring them into the surrounding air. The most common and ubiquitous example of this process is water evaporation from sunlight. The magnitude of the effect is dependent on the photons' wavelength, polarization, intensity, and incident angle. Recent advances in light-emitting diode (LED) technology and other photonic devices have made the meaningful generation of light and light with specific wavelengths in compact areas cost effective.

### SUMMARY

The present disclosure provides systems that leverage the photomolecular effect using various sources capable of emitting photons with tailored properties by incorporating photon emitting elements into drying and evaporation devices. Incorporating photon emitting elements into such devices can enhance evaporation, reducing the time and energy required for the process. The photon generators would be the appropriate size and configuration to complement existing drying and evaporating devices and would be configured to maximize the photomolecular effect.

Incidence Angle Definition—Unless stated otherwise, “incidence angle” means the angle between the incoming photon path and the surface normal of the irradiated liquid-air (or liquid-vapor) interface, measured in the external medium (usually air). For a two-layer air-water interface, the Brewster angle θ_B is approximately 53° from the normal. The embodiments disclosed herein may employ an incidence angle (also referred to herein simply as “incidence”) between 40° and 60°, or the embodiments may employ incidence within ±5° of the Brewster angle of the specific interface, the latter being calculated from refractive indices of all layers including any intermediate glass window, polymer film, hydrogel, or coating.

Polarization Definition—“TM-polarized,” “p-polarized,” and “linearly-polarized (as used herein)” all refer to transverse magnetic light whose electric field vector lies in the plane of incidence. Unless otherwise specified, references to polarized light in this specification and the claims mean TM polarization, i.e., “transverse-magnetic polarization.”

Disclosed herein are devices and methods for performing drying, dehumidifying, dehydrating, and/or evaporating liquids. The devices and methods utilize photons, such as those generated by LED lights, configured to elicit NTPI evaporation to improve the efficiency and effectiveness of the devices in drying, dehumidifying, dehydrating, and/or evaporating liquids.

Experimental studies show that the photomolecular evaporation rate is highest when TM-polarized visible light, especially within the 495 nm to 570 nm (“green”) band, strikes the air-water interface at an incidence of about 40°-55° from the surface normal, i.e., close to the Brewster angle (≈53° for air-to-water). Light outside this angular window, of other polarizations, or at different wavelengths can still induce NTPI evaporation, but typically with lower efficiency.

One embodiment disclosed herein is directed to a clothes dryer for drying wet clothing and fabrics. The clothes dryer may be a residential appliance or a commercial-grade dryer such as those used in laundromats or dry-cleaning establishments. In one embodiment, a clothes dryer comprises a housing. The housing contains a rotatable drum with baffles for holding clothes and a vent for circulating air through the drum. A plurality of arrays of lights are positioned within the drum and configured to emit light at a wavelength optimized for inducing a photomolecular effect in water molecules. The photomolecular effect accelerates the drying process by cleaving water molecules from the fabric surface and converting them from a liquid state to a vapor state. In another aspect, the lights may be configured to emit photons at wavelength in the green spectrum, for example, photons having a wavelength of about 520 nm, or from 495-570 nm, or from 425-540 nm. The emission of photons and light at particular wavelengths and ranges of wavelengths are stated herein. As used herein, these statements mean that the emission of photons and light is primarily within a band of the specified wavelength, i.e., more than half of the energy of the emitted photons and light is emitted within plus or minus 5% of the specified wavelength.

In another aspect, the lights may be configured to direct photons toward the interface at an incidence within the range defined herein. In another aspect, the lights may emit TM-polarized light to enhance NTPI evaporation. In another aspect, the baffles may be made of translucent material, allowing light to contact more of the surface of the clothes. A control unit is included to manage the operation of the drum rotation, heating, air circulation, and lighting arrays, allowing for efficient and effective drying of various fabric types and load sizes.

Another embodiment disclosed herein is directed to a solvent extractor (also referred to as a “solvent extraction apparatus”) for separating solvents from various liquids. The solvent extractor may be used in laboratory settings, industrial processes, or in environmental remediation efforts. In one embodiment, a solvent extractor comprises a sealed chamber or flask. The chamber rests on a sample platform with a heating element for holding the chamber from which solvent is to be extracted. The extractor also includes a condensing unit and a collection container for the extracted solvent. At least one array of lights is configured to emit photons at wavelengths optimized for inducing NTPI evaporation in the particular solvent being extracted, or in one or more particular chemical components of a solvent mixture. The wavelength can be tuned to a wavelength that is optimal for the particular solvent or chemical component. This photomolecular effect facilitates the separation of solvent molecules from the sample, improving extraction efficiency. In another aspect, the solvent extractor may include adjustable fixtures for mounting the light arrays which allow for optimization of light direction and coverage. In still another aspect, a control unit may be provided to adjust the intensity and wavelength of the light arrays, as well as manage heating, agitation and polarization. Light sources may be LED arrays or pulsed laser diodes. The control unit supports modulation of wavelength, polarization, pulse duration, and duty cycle to target specific fluids and optimize cluster ejection dynamics. In another aspect, a rotational device, driven by a motor, may be included to agitate the surface of the solvent, enhancing the extraction process by increasing the surface area of the solvent/medium interface that is exposed to the light emitted by the light arrays. In another aspect, the solvent extractor may further comprise one or more ultrasonic transducers positioned to generate cavitation in the solvent, wherein the ultrasonic transducers operate at frequencies optimized to enhance vaporization within the solvent in conjunction with NTPI evaporation.

Another embodiment disclosed herein is directed to an indirect evaporative cooler for cooling air in residential, commercial, or industrial settings without adding moisture to the primary air stream. In one embodiment, an indirect evaporative cooler comprises a housing containing several components for efficient cooling. The cooler comprises a primary air blower and a secondary air blower to manage separate air streams. A primary air return allows for the recirculation of cooled air. The housing also includes a secondary air exhaust vent to expel the air used in the evaporation process. Inside the housing, evaporation media facilitates the cooling process, the media interface may include micro- or nano-scale porous structures, hydrogels, or patterned surfaces to increase liquid-air contact area and enhance NTPI evaporation efficiency. A water reservoir at the base collects, recycles, and supplies water to the system. A pump and water pipe network distribute water to a sprayer/mister, which applies water to the evaporation media. A control unit may be included to manage the operation of the blowers, pump, and light arrays, allowing for efficient and effective cooling under various environmental conditions and cooling demands. The control unit may employ sensors (e.g., humidity, temperature, optical moisture detectors) that feed back to the control unit. The control unit adjusts photon emission parameters in real time to maintain desired dryness levels with minimal energy.

A unique feature of this cooler is the incorporation of water-resistant light arrays positioned to emit light onto the evaporation media and water droplets. These light arrays are configured to emit light at a wavelength optimized for inducing NTPI evaporation in water molecules. In one aspect, the LED lights may be configured to emit photons at wavelengths in the green spectrum, for example, photons having a wavelength of about 520 nm, or from 495-570 nm, or from 425-540 nm. In another aspect, the LED array may be configured such that the photons strike the water droplets or mist within the range defined herein. In yet another aspect, the LED lights may emit linearly polarized light to enhance NTPI evaporation. In yet another aspect, the evaporation-media may be made of a translucent material that optimizes light transmission, allowing the photomolecular effect to penetrate deeper into the media.

Another embodiment disclosed herein is directed to a direct evaporative cooler for cooling air in residential, commercial, or industrial settings. In one embodiment, a direct evaporative cooler comprises a housing. The housing contains a fan or blower for air circulation, vertically arranged evaporative cooling pads or media, and a water reservoir at the base. The evaporation-media facilitates the cooling process. The media interface may include micro- or nano-scale porous structures, hydrogels, or patterned surfaces to increase the liquid-air direct contact area and enhance NTPI evaporation efficiency. An array of water-resistant LED lights is positioned at the top of the housing, directing light down onto the media and interstices. The LED array is configured to emit light at wavelengths optimized for inducing NTPI evaporation in water molecules. A control unit may be included to manage the operation of the fan, water pump, and LED array, allowing for efficient and effective cooling under various environmental conditions and cooling demands. The control unit may employ sensors (e.g., humidity, temperature, optical moisture detectors) that feed back to the control unit. The control unit adjusts photon emission parameters in real-time to maintain desired dryness levels with optimal energy.

In one aspect, the LED lights may be configured to emit photons at wavelengths in the green spectrum, for example, photons having a wavelength of about 520 nm, or from 495-570 nm, or from 425-540 nm. In another aspect, the LED array may be configured such that the photons strike the water droplets or mist within the range defined herein. In yet another aspect, the LED lights emit TM-polarized light to enhance NTPI evaporation. In yet another aspect, the evaporation media is made of a translucent material that optimizes light transmission, allowing the photomolecular effect to penetrate deeper into the media.

Another embodiment disclosed herein is directed to a food dehydrator (also referred to as a “food dehydration apparatus”) for preserving food by removing moisture. This food dehydrator may be used in home kitchens, commercial food preparation, or agricultural or aquacultural settings. The apparatus is particularly suited for, but not limited to, dehydrating food items. It can also be effectively used for drying other organic materials such as algae. These materials may be processed for various purposes, including but not limited to human consumption, animal feed, nutritional products, and agricultural soil amendments. In one embodiment, a food dehydrator comprises an enclosure. In another aspect, the enclosure may comprise a cabinet with multiple removable trays for holding food items. An array of lights is positioned to provide substantially uniform coverage of food items on the trays and the surrounding air. As used herein, the terms “substantial” and “substantially” mean within a 20% range of the stated element. These lights are configured to emit light at wavelengths that induce NTPI evaporation in water molecules, facilitating their removal from the food items. The dehydrator includes a low-heat (i.e., <40° C.) air circulation system to distribute the dehydrating effect evenly and carry away moisture. A control unit is provided to manage the operation of the lights, heating, and air circulation system, allowing for customized dehydration processes for diverse types of food or agricultural products. The control unit may employ sensors (e.g., humidity, temperature, optical moisture detectors) that feed back to the control unit. The control unit is configured to adjust photon emission parameters in real-time to maintain desired dryness levels with optimal energy. In another aspect, the lights are configured to emit photons at wavelength in the green spectrum, for example, photons having a wavelength of about 520 nm, or from 495-570 nm, or from 425-540 nm. In another aspect, the lights are configured such that the photons strike the air-water interface within the range defined herein. In another aspect, the lights may emit TM-polarized light to enhance NTPI evaporation. In another aspect, the trays are made of translucent material, allowing light to contact more of the surface of the material.

Another embodiment disclosed herein is directed to a regenerating desiccator for continuous dehumidification with photomolecular regeneration. The apparatus may be used, for example, in HVAC systems, industrial drying processes, laboratory settings, or compressed air systems. In one embodiment, a regenerating desiccator comprises a rotatable wheel containing desiccant or sorbent material. The wheel is divided into at least two zones: an absorption zone where moisture from process air is absorbed by a sorbent material, and a regeneration zone where the absorbed moisture is removed from the sorbent. A drive mechanism is operably coupled to the wheel to rotate the wheel such that portions of the wheel rotate between the absorption zone and the regeneration zone.

Arrays of lights are positioned in the regeneration zone and configured to emit light at wavelengths optimized for inducing NTPI evaporation in the absorbed water molecules within the sorbent material. This photomolecular effect facilitates the desorption of water from the sorbent at lower temperatures than conventional thermal regeneration. A control unit is operably coupled to the drive mechanism and the light arrays and is configured to manage the rotation speed of the wheel and the operation of the light arrays to optimize the continuous absorption-regeneration cycle. In another aspect, the lights may be configured to emit photons at wavelengths in the green spectrum, for example, photons having a wavelength of about 520 nm, or from 495-570 nm, or from 425-540 nm. In another aspect, the sorbent material may be selected or treated to be optically transparent or translucent to allow deeper penetration of the photomolecular effect. In yet another aspect, the lights emit TM-polarized light to enhance NTPI evaporation within the porous structure of the sorbent.

Another embodiment disclosed herein is directed to a microfluidic device utilizing NTPI evaporation for fluid manipulation without mechanical components. This device may be used in lab-on-chip applications, point-of-care diagnostics, chemical synthesis, or biological assays. In one embodiment, a microfluidic device comprises a chip substrate containing a network of microchannels with precisely controlled liquid-air interfaces. One or more focused light sources, which may be single or multi-wavelength lasers or LED arrays, are positioned to direct light beams at specific locations along the microchannels where liquid-air interfaces exist. The light sources are configured to emit photons at wavelengths optimized for inducing NTPI evaporation in the working fluid. By selectively activating light sources at different locations, localized evaporation creates pressure differentials that drive fluid pumping, mixing, or valving operations without any moving mechanical parts. In another aspect, the light sources may operate in continuous or pulse modes to control the rate and direction of fluid movement. In another aspect, the microchannels may incorporate expansion chambers or geometric features that enhance the formation of stable liquid-air interfaces for optical actuation. In yet another aspect, multiple wavelengths may be employed simultaneously to selectively evaporate different components in multi-phase or multi-component fluid systems. A control unit coordinates the timing, intensity, and wavelength of the light sources to achieve complex fluidic operations including droplet generation, sorting, and routing.

### BRIEF DESCRIPTION OF THE DRAWINGS

FIG. 1 is a schematic drawing illustrating a regenerating desiccator having light sources (e.g., LED arrays) configured for non-thermal photon-induced evaporation in a regeneration zone for non-thermal photon-induced evaporation desorption of moisture from a rotating desiccant wheel, according to one embodiment.

FIG. 2 is a schematic drawing illustrating a clothes dryer having light sources (e.g., LED arrays) configured for non-thermal photon-induced evaporation arranged in a pattern to bathe the inside of a clothes dryer, according to one embodiment.

FIG. 3 is a schematic drawing illustrating a solvent extractor having light sources (e.g., LED arrays) configured for non-thermal photon-induced evaporation tuned to an optimal wavelength, polarization, and angle for separation of specific solvents.

FIG. 4 is a schematic drawing illustrating an indirect evaporative cooler having light sources (e.g., LED arrays) configured for non-thermal photon-induced evaporation and translucent heat exchangers, according to one embodiment.

FIG. 5 is a schematic drawing illustrating a direct evaporative cooler having light sources (e.g., LED arrays) configured for non-thermal photon-induced evaporation and translucent heat exchangers, according to one embodiment.

FIG. 6 is a schematic drawing illustrating a food dehydrator having light sources (e.g., LED arrays) configured for non-thermal photon-induced evaporation and translucent trays to a food dehydrator, according to one embodiment.

FIG. 7 shows a microfluidic device having light sources (e.g., LED arrays) configured for non-thermal photon-induced evaporation for valveless fluid pumping and manipulation through actuation at liquid-air interfaces, according to one embodiment.

FIG. 8 is a schematic drawing illustrating a generic apparatus for enhancing drying, dehumidifying, cooling, dehydrating, and evaporating processes utilizing direct, non-thermal photon-induced removal of liquid molecules from a surface, according to one embodiment.

The drawings are not intended to be limiting in any way, and it is contemplated that various examples of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

Before the examples are described, it is to be understood that the invention is not limited to the particular examples described, as such may, of course, vary. It is also to be understood that the terminology used herein is for the purpose of describing particular examples only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, some potential and exemplary methods and materials are now described.

It must be noted that as used herein and in the appended claims, the singular forms “a,” “an,” and “the” include plural referents unless the context clearly dictates otherwise. Thus, for example, reference to “a compound” includes a plurality of such compounds and reference to “the polymer” includes reference to one or more polymers and equivalents thereof known to those skilled in the art, and so forth.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number. In most cases, the substantial equivalent is provided within a range of plus or minus 10% of the stated number or range of numbers.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the scope of the appended claims.

### 1. Regenerating Desiccator

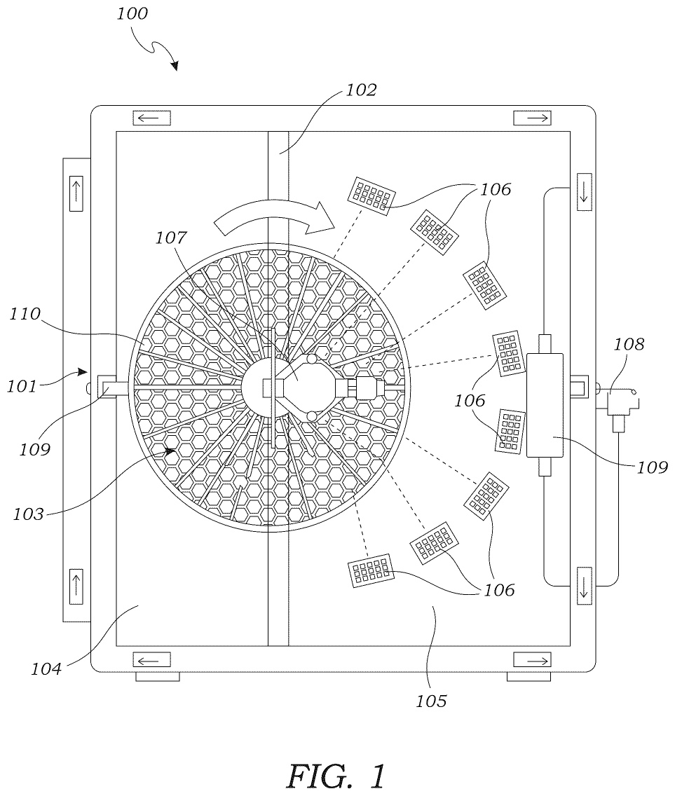

Referring now to FIG. 1, a regenerating desiccator apparatus (100) for continuous dehumidification with photomolecular regeneration is disclosed. The apparatus (100) comprises a housing (101) divided by an internal partition (102) creating two distinct operational zones. A rotatable desiccant wheel (103) containing porous desiccant material (110) is mounted perpendicular to the partition (102), allowing continuous rotation between an absorption zone (104) and a regeneration zone (105). The wheel (103) features a honeycomb or corrugated structure maximizing surface area while permitting air flow.

In the absorption zone (104), moisture-laden process air enters through an inlet, passes through the rotating desiccant wheel (103) where water molecules are adsorbed, and exits as dry air. The regeneration zone (105) includes arrays of LED lights (106) which emit light onto the desiccant material. These LED arrays (106) emit light at wavelengths optimized for inducing non-thermal photon-induced (NTPI) evaporation in absorbed water molecules, enabling desorption at significantly lower temperatures than conventional thermal regeneration.

A drive mechanism (107) provides controlled wheel rotation, ensuring each desiccant section spends appropriate time in both zones. A control unit (108) coordinates system operation, regulating rotation speed and LED parameters including intensity, wavelength, and duty cycle. Temperature and humidity sensors (109) in both zones provide real-time feedback for optimization.

In one aspect, the LED arrays (106) emit photons at wavelengths in the green spectrum, such as 520 nm, or from 495-570 nm. In another aspect, the arrays emit TM-polarized light to enhance NTPI evaporation. The desiccant material (110) may be optically translucent for deeper light penetration.

During operation, regeneration air flow carries away water vapor released by the photomolecular effect through a moist air outlet. This flow can operate at lower temperatures than conventional systems since desorption energy comes primarily from photon interaction rather than heat.

### 2. Clothes Drying Apparatus

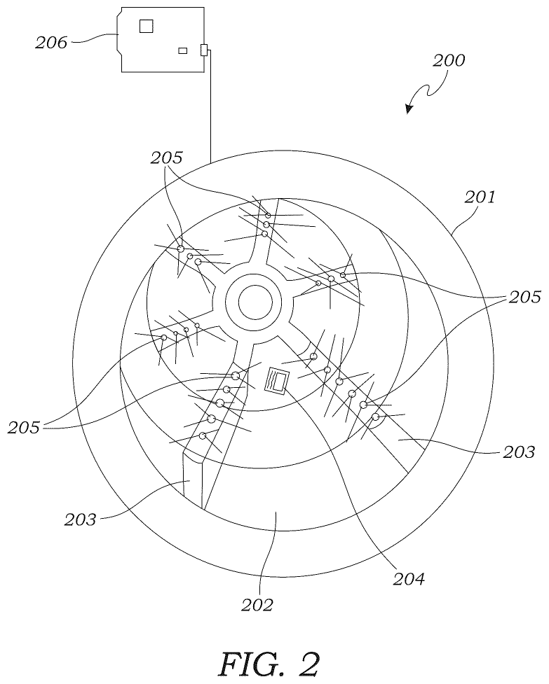

Turning now to FIG. 2, a clothes-drying apparatus (200) is disclosed. The clothes drying apparatus (200) includes a housing (201) containing a rotating drum (202) mounted within. Attached to the rotating drum (202) are one or more baffles (203) that lift and tumble the clothes into the airspace of the drum (202) as it rotates. The embodiment comprises a ventilation system (204) configured to circulate air through the drum (202). Multiple arrays of lights (205) are disposed within the drum (202). These light arrays (205) are configured to emit light to induce non-thermal photon-induced (NTPI) evaporation in water molecules on the clothes. The clothes-drying apparatus (200) may include a control unit (206) operatively coupled to the ventilation system (204) and the light arrays (205). The control unit (206) may connect to a user interface for selecting drying cycles and options. In one aspect, the light arrays (205) may be configured to emit photons at wavelengths in the green light spectrum, for example, photons having a wavelength of about 520 nm, or from 495-570 nm, or from 425-540 nm. In another aspect, the light arrays (205) may emit TM-polarized light to optimize NTPI evaporation. In yet another aspect, the baffles are made of a translucent material that allows light to reach more of the surface areas of the clothes.

### 3. Solvent Extraction Apparatus

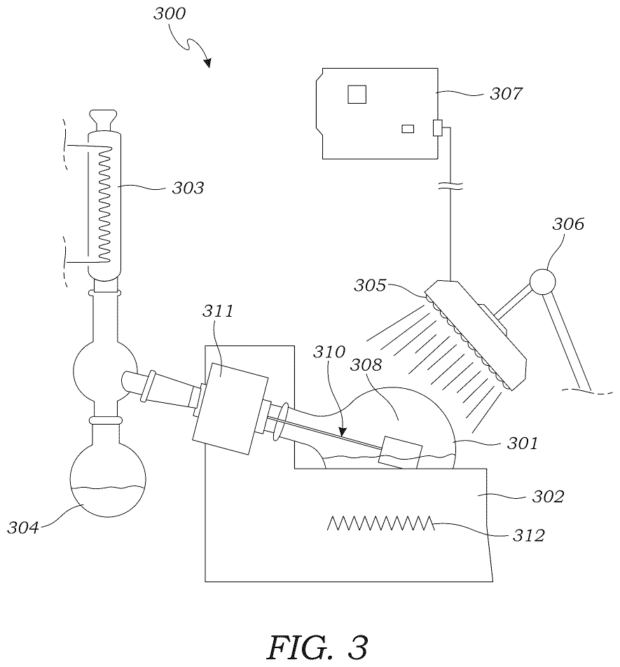

Turning now to FIG. 3, a solvent extraction apparatus (300) is disclosed. This embodiment comprises a sealable chamber (301) mounted on a sample platform (302). The sample platform (302) includes an integrated heating platform (312). The solvent extraction apparatus (300) includes a condensing unit (303) and a collection receptacle (304) for the extracted solvent, both in fluid communication with the chamber (301). The solvent extraction apparatus (300) may also include an agitation mechanism (310) disposed within the chamber (301) which is configured to disturb the surface of the solvent contained within the chamber (301). A motor (311) is operatively coupled to the agitation mechanism to operate the agitation mechanism (310). At least one array of LED lights (305) is mounted on one or more adjustable fixtures (306) positioned to illuminate the contents of the chamber (301). A control unit (307) is provided to modulate the intensity and wavelength of light emitted by the LED lights (305). In another aspect, the LED lights (305) may be configured to emit photons at wavelengths optimal to the evaporation of the solvent molecule. In another aspect, the LED lights (305) are configured and arranged using adjustable fixtures such that the photons strike the solvent surface within the range defined herein. In yet another embodiment, the LED lights (305) emit TM-polarized light to optimize non-thermal photon-induced (NTPI) evaporation. In yet another aspect, an agitation mechanism (310) driven by a motor (311) may be used to increase the surface area of the solvent/air interface. The control unit (307) may also regulate the heating element (302) and agitation mechanism (310) for optimized solvent extraction.

### 4. Indirect Evaporative Cooler

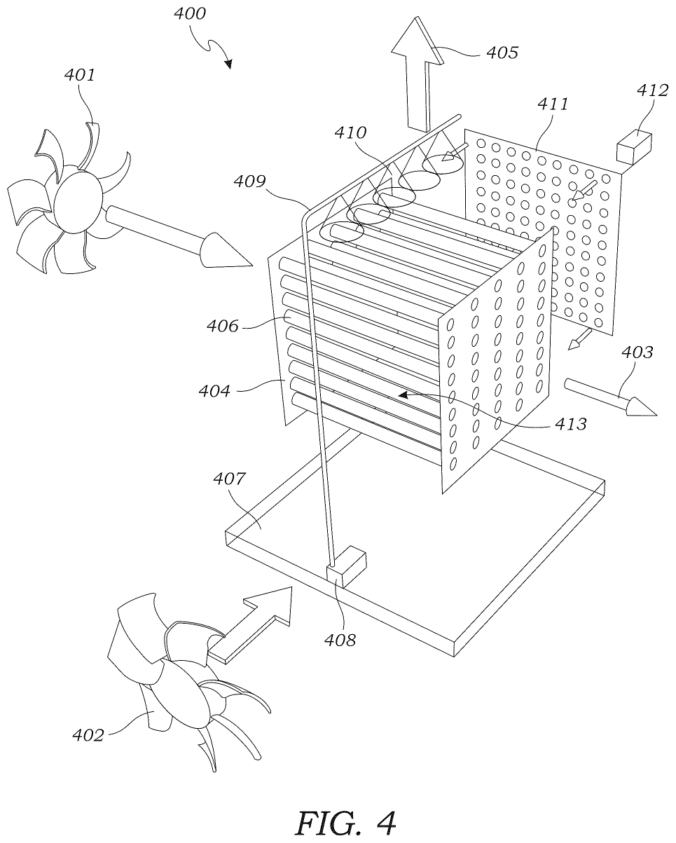

Turning now to FIG. 4, an indirect evaporative cooler (400) is disclosed. The cooler (400) comprises a housing (404) that contains a primary air blower (401), a secondary air blower (402), a primary air return (403), a heat exchanger (413) a secondary air exhaust vent (405), evaporation media (406) contained within the heat exchanger (413) (e.g., water, refrigerant, coolant, or the like), a water reservoir (407), a pump (408), a water pipe (409), a water sprayer/mister (410), and water-resistant light arrays (411) positioned to illuminate the water droplets and evaporation media (406) in the housing (404). The indirect evaporative cooler (400) may include a control unit (412) operably coupled to, and configured to regulate the operation of, the primary and secondary air blowers (401) (402), pump (408), and light arrays (411). The control unit (412) may also monitor and adjust the cooling process for optimal efficiency.

In one aspect, the light arrays (411) may be configured to emit photons at wavelengths in the green light spectrum, for example, photons having a wavelength of about 520 nm, or from 495-570 nm, or from 425-540 nm. In another aspect, the light arrays (411) may be configured and arranged such that the photons strike the water droplets within the range defined herein. In yet another aspect, the light arrays (411) emit TM-polarized light to optimize the photomolecular effect on the water droplets, enhancing the evaporation process. In yet another aspect, the evaporation media (406) can be selected for its ability to transmit light, optimizing both light transparency and water-absorbent properties.

### 5. Direct Evaporative Cooler

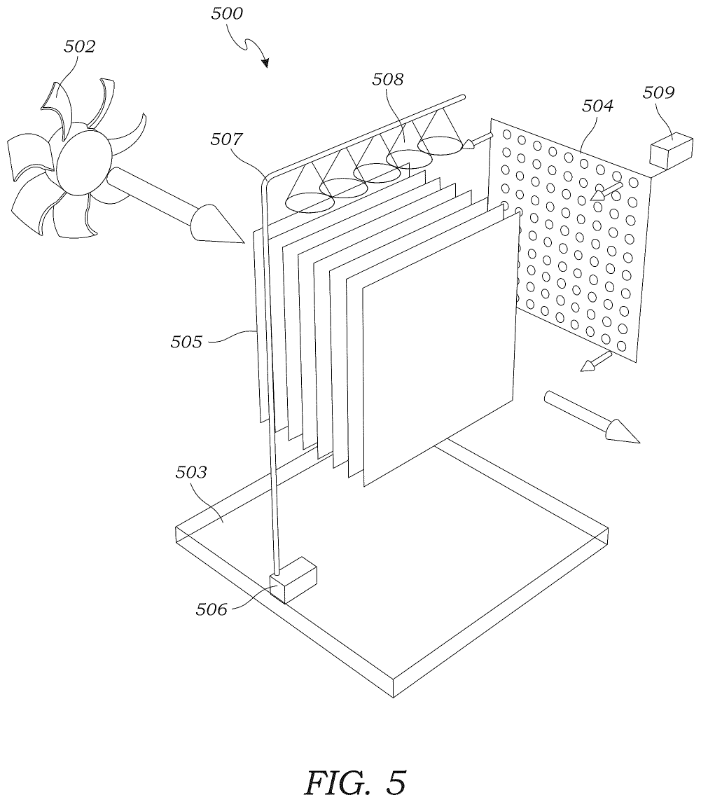

Referring now to FIG. 5, a direct evaporative cooler (500) with recirculating water spray is disclosed. The direct evaporative cooler (500) comprises a housing (not shown). The housing contains a fan or blower (502) for air circulation, a water reservoir (503) at the base of the housing, an array of water-resistant LED lights (504), evaporation media (505) (e.g., water, refrigerant, coolant, or the like), a pump (506), a water pipe (507), and a water sprayer/mister (508). The LED array (504) is configured to emit light at wavelengths optimized for inducing a photomolecular effect in water molecules. In another aspect, a control unit (509) may be included to manage the operation of the fan (502), and LED array (504), allowing for efficient and effective cooling under various environmental conditions and cooling demands.

In one aspect, the LED lights (504) are configured to emit photons at wavelengths in the green spectrum, for example, photons having a wavelength of about 520 nm, or from 495-570 nm, or from 425-540 nm. In another aspect, the LED array (504) may be configured such that the photons strike the water droplets or mist within the range defined herein as they pass through the cooling media (505). In yet another aspect, the LED lights (504) may emit TM-polarized light to enhance non-thermal photon-induced evaporation (NTPI). In yet another aspect, the evaporation media (505) may be composed of a light-permeable material, optimizing photon penetration and expanding the effective area for NTPI evaporation. In yet another aspect, the evaporation media (505) may be submerged at the base in a reservoir of water (503), drawing the water up without the need for a recirculation system.

### 6. Food Dehydration Apparatus

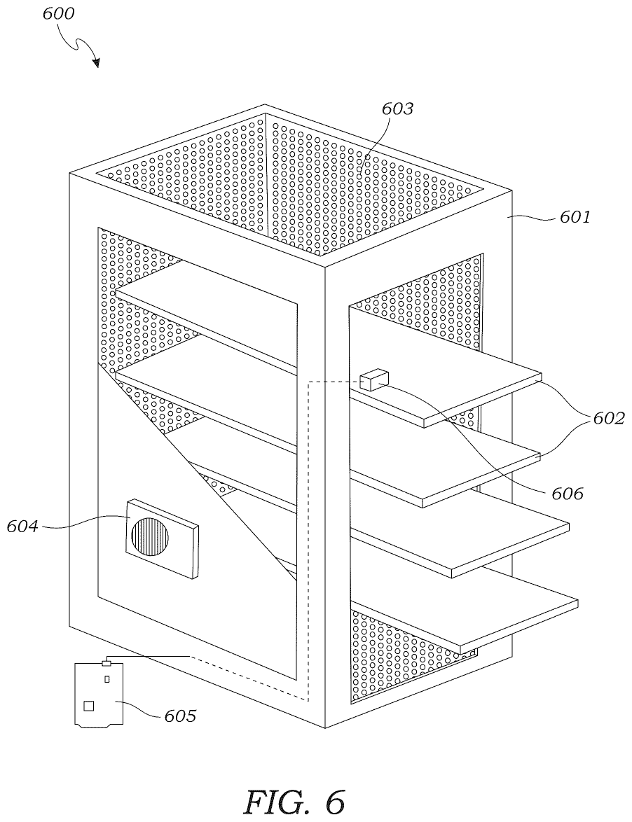

With reference to FIG. 6, another embodiment disclosed herein is directed to a food dehydration apparatus (600) (also referred to herein as a “dehydrator” and “food dehydrator”). The apparatus (600) comprises an enclosure (601) housing multiple removable trays (602). Arrays of LED lights (603) are disposed within the enclosure to provide illumination of items placed on the trays (602) and the airspace throughout the enclosure (601). The apparatus (600) comprises a low-temperature air circulation system (604) that ensures air flow throughout the enclosure (601). This may include a fan and heating elements for temperature control. In another aspect, a control unit (605) may be provided to regulate the operation of both the LED lights (603) and the air circulation system (604). The control unit (605) may connect to a user interface for selecting dehydration cycles and options.

The dehydration apparatus (600) also includes one or more sensors (606). The sensors (606) may include a humidity sensor, a temperature sensor, an optical moisture detector, and the like. The sensor(s) 606 are operably coupled to the control unit (605) to provide a respective sensor signal to the control unit (605). The control unit (605) is configured to use the sensor signals to control the operation of the dehydration apparatus (600) based on the sensor signals, including adjusting photo emission parameters to maintain a desired dryness level. In another aspect, the LED lights (603) are configured to emit photons at wavelengths in the green light spectrum, for example, photons having a wavelength of about 520 nm, or from 495-570 nm, or from 425-540 nm. In another aspect, the LED lights (603) are configured and arranged such that the photons strike the food surfaces within the range defined herein. In yet another aspect, the removable trays (602) may be translucent or mesh to reduce shadowing and to allow more light to reach the undersides of the dehydrating materials. In yet another aspect, the LED lights (603) may be configured to emit TM-polarized light to optimize the photomolecular effect, enhancing the dehydration process.

### 7. Microfluidic Pump

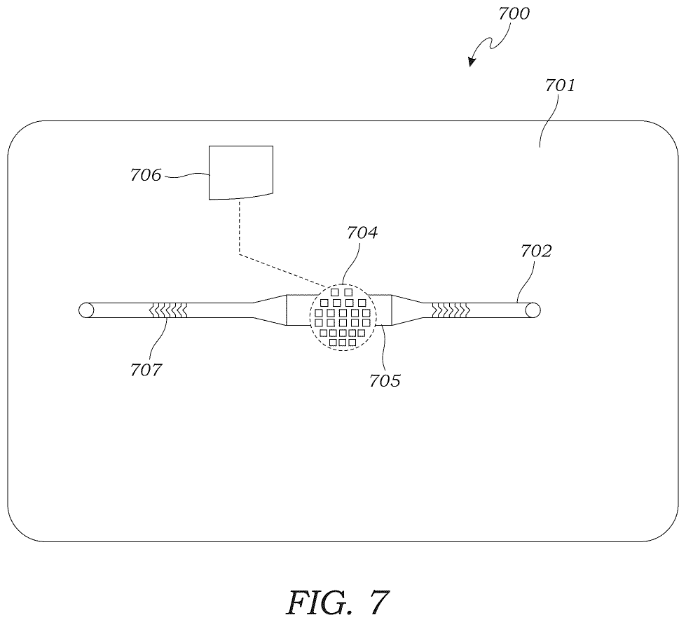

Turning now to FIG. 7, an embodiment of the invention is directed to a microfluidic apparatus (700) which utilizes non-thermal photon-induced (NTPI) evaporation for fluid manipulation without mechanical moving parts or the introduction of significant heat. The microfluidic apparatus (700) comprises a substrate (701) fabricated from an optically transparent material, such as glass, quartz, or a polymer. The substrate (701) defines a network of microchannels (702). The microfluidic apparatus (700) includes unidirectional valves (707) disposed at locations within the microchannels (702) to ensure unidirectional fluid flow. The microchannels (702) further comprise features such as expansion chambers (705), which are configured to contain a working fluid and stabilize the formation of liquid-air interfaces where evaporation can be induced.

### 8. Non-Thermal Photon-Induced Evaporation Apparatus

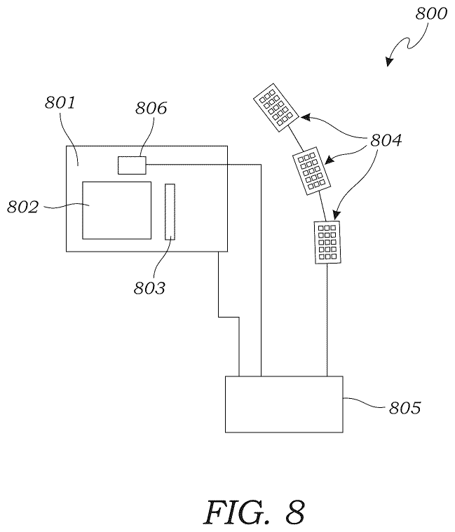

Turning now to FIG. 8, an apparatus (800) for enhancing drying, dehumidifying, cooling, dehydrating, and evaporating processes utilizing direct, non-thermal photon-induced removal of liquid molecules from a surface is illustrated. The apparatus (800) includes a support structure (801), which may be a housing, frame or other suitable assembly for supporting and/or containing the components of the apparatus (800). The apparatus (800) includes a liquid handling assembly (802) having a liquid-vapor interface (803). The liquid handling assembly (802) may include any suitable tubes, pumps, evaporation media and the like for handling a liquid being processed by the apparatus (800). The apparatus (800) further comprises one or more photon-emitting light sources (804) (e.g., an array) oriented so that a principal ray impinges on the liquid-vapor interface (803) at an incidence within about 40°-60° from the surface normal, and preferably within ±5° of the Brewster angle of the interface (803). The light sources (804) are configured to emit predominantly TM-polarized photons in the 495 nm-570 nm band at an intensity sufficient to induce non-thermal photon-induced evaporation. The apparatus (800) also has a control unit (805) operatively coupled to the light sources and the liquid handling assembly (802). The control unit (805) is configured to selectively activate, pulse, or modulate the light sources (804) to create localized non-thermal evaporation of a liquid within the liquid handling assembly (802), and/or to control the liquid handling assembly.

In another aspect of the apparatus (800) the one or more light sources (804) may comprise one of micro-LEDs, VCSELs, and laser diodes capable of continuous-wave or pulsed operation. In yet another aspect, the control unit (805) may be configured to modulate wavelength, pulse duration, repetition rate, duty cycle, and peak irradiance to regulate fluid-flow rate and direction. In still another aspect, the apparatus (800) may further comprise integrated sensors (806) configured to provide feedback to the control unit (805) for closed-loop adjustment of photon-emission parameters. The sensors (806) may include one or more of pressure sensors, temperature sensors, optical turbidity sensors, and flow-rate sensors. In another aspect, at least one of the light sources (804) may be a multi-wavelength array capable of independently addressing two or more spectral sub-bands so as to selectively evaporate different constituents of a multi-component fluid.

The microfluidic apparatus (700) further comprises one or more light sources (704) positioned to irradiate the working fluid. The light sources (704) are configured to direct focused light beams precisely at the liquid-air interfaces, for example, within the expansion chambers (705). These light sources (704) may comprise laser diodes, micro-LED arrays, or optical fibers coupled to external sources. The light sources (704) emit photons at wavelengths specifically chosen to optimize NTPI evaporation in the working fluid, typically in the range of 495-570 nm for aqueous solutions. This effect causes direct, non-thermal evaporation of the fluid, generating a pressure differential with minimal localized heating.

A control unit (706) is communicatively coupled to the light sources (704). The control unit (706) coordinates the microfluidic apparatus (700) by selectively activating individual light sources (704) to create localized evaporation at specific interfaces via NTPI evaporation. This targeted evaporation generates a pressure differential that, when combined with the action of the unidirectional valves (707), drives directional fluid movement through the microchannels (702). The control unit (706) modulates parameters including light intensity, pulse duration, and duty cycle to precisely control flow rate and pattern. For pumping, sequential activation of light sources (704) along a channel creates a peristaltic-like pumping effect. For valving, intense illumination at a constriction can create a vapor barrier, blocking flow. For mixing, alternating activation patterns can generate fluidic advection. The control unit (706) can thereby execute programmed sequences for operations including droplet generation, sorting, merging, and routing through purely optical means without reliance on mechanical pumps or thermal gradients. This method of photomolecular actuation eliminates mechanical wear and enables the creation of highly integrated lab-on-chip applications, point-of-care diagnostics, and chemical synthesis platforms.

Although particular embodiments of the disclosed inventions have been shown and described herein, it will be understood by those skilled in the art that they are not intended to limit the present inventions, and it will be obvious to those skilled in the art that various changes and modifications may be made (e.g., the dimensions of various parts) without departing from the scope of the disclosed inventions, which is to be defined only by the following claims and their equivalents. The specification and drawings are, accordingly, to be regarded in an illustrative rather than restrictive sense. The various embodiments of the disclosed inventions shown and described herein are intended to cover alternatives, modifications, and equivalents of the disclosed inventions, which may be included within the scope of the appended claims.

1. An apparatus, comprising:
a support structure;
a liquid handling assembly having a liquid-vapor interface;
one or more photon-emitting light sources oriented so that a principal ray impinges on the liquid-vapor interface at an incidence within about 40°-60° from the surface normal, and within ±5° of the Brewster angle of said interface, the light sources being configured to emit predominantly TM-polarized photons in the 495-570 nm band at an intensity sufficient to induce non-thermal photon-induced evaporation;
a control unit operatively coupled to the light sources, the control unit being configured to selectively activate, pulse, or modulate the light sources to create localized non-thermal evaporation of a liquid within the liquid handling assembly.

2. The apparatus of claim 1, wherein the one or more light sources comprise one of micro-LEDs, VCSELs, and laser diodes capable of continuous-wave or pulsed operation.

3. The apparatus of claim 1, wherein the control unit modulates wavelength, pulse duration, repetition rate, duty cycle, and peak irradiance to regulate fluid-flow rate and direction.

4. The apparatus of claim 1, further comprising integrated sensors selected from the group consisting of pressure, temperature, optical turbidity, and flow-rate sensors, the sensors providing feedback to the control unit for closed-loop adjustment of photon-emission parameters.

5. The apparatus of claim 1, wherein at least one light source is a multi-wavelength array capable of independently addressing two or more spectral sub-bands so as to selectively evaporate different constituents of a multi-component fluid.

6. The apparatus of claim 1, wherein the control unit is configured to coordinate the one or more photon-emitting light sources to regulate the light sources and the liquid handling assembly.

7-12. (canceled)

13. A clothes-drying apparatus, comprising:
a housing;
a rotatable drum rotatably mounted within said housing, the drum having baffles within the drum;
a ventilation system configured to circulate heated air through said drum; and
a plurality of light arrays disposed within said drum, said arrays configured to emit light at a wavelength optimized for inducing non-thermal photon-induced evaporation in water molecules;

14. The clothes-drying apparatus of claim 13, wherein the plurality of light arrays is configured to emit photons having a wavelength of about 520 nm.

15. The clothes drying apparatus of claim 13, wherein the plurality of light arrays is configured to emit photons having a wavelength of from 495-570 nm.

16. The clothes-drying apparatus of claim 13, wherein the one or more lights emit TM-polarized light.

17. The clothes-drying apparatus of claim 13, wherein the plurality of light arrays is oriented so that photons impinge on a moisture-bearing fabric surface within the drum at an incidence between about 40° and about 60° from the surface normal, and within ±5° of the Brewster angle of the air-water interface.

18. The clothes-drying apparatus of claim 13, further comprising:
a control unit operatively coupled to the drum, ventilation system, and plurality of light arrays to control the operation of the drum, ventilation system, and plurality of light arrays.

19. The clothes-drying apparatus of claim 13, wherein the baffles are made of a translucent material.

20-32. (canceled)

33. A direct evaporative cooler, comprising:
a housing;
a fan configured to circulate air through the housing;
evaporation media disposed within the housing, the evaporation media arranged to facilitate direct contact between circulating air and water;
a water reservoir for storing water;
a water distribution system for circulating the water through the direct evaporative cooler; and
one or more water-resistant light arrays positioned to emit light onto the evaporation media and water droplets on the evaporation media, said light arrays configured to emit light at wavelengths optimized for inducing non-thermal photon-induced evaporation in water molecules, thereby enhancing evaporation and cooling efficiency.

34. The direct evaporative cooler of claim 33, wherein the one or more water-resistant light arrays is configured to emit photons having a wavelength of about 520 nm.

35. The direct evaporative cooler of claim 33, wherein the one or more water-resistant light arrays is configured to emit photons having a wavelength of from 495-570 nm.

36. The direct evaporative cooler of claim 33, wherein the one or more water-resistant light arrays emits TM-polarized light.

37. The direct evaporative cooler of claim 33, wherein the one or more water-resistant light arrays are oriented so that photons impinge on the water droplets or wetted media at an incidence between about 40° and about 60° from the surface normal, and within ±5° of the Brewster angle of the air-water interface.

38. The direct evaporative cooler of claim 33, wherein the evaporation media is composed of a light-permeable material.

39. The direct evaporative cooler of claim 33, further comprising:
a control unit operatively coupled to the fan, water distribution system and one or more water-resistant light arrays, said control unit configured to regulate operation of the fan, water distribution system and water-resistant light arrays based on environmental conditions and cooling demands.

40-55. (canceled)
